(19) United States
(12) Patent Application Publication
(10) Pub. No.: US 2013/0080401 A1
(43) Pub. Date: Mar. 28, 2013

(54) SYSTEM FOR HIERARCHICAL INFORMATION COLLECTION

(71) Applicants: Tomonori MAEGAWA, Tokyo (JP); Toshio ITO, Kawasaki-shi (JP); Shigeo MATSUZAWA, Chofu-shi (JP)

(72) Inventors: Tomonori MAEGAWA, Tokyo (JP); Toshio ITO, Kawasaki-shi (JP); Shigeo MATSUZAWA, Chofu-shi (JP)

(73) Assignee: KABUSHIKI KAISHA TOSHIBA, Tokyo (JP)

(21) Appl. No.: 13/565,236

(22) Filed: Aug. 2, 2012

(30) Foreign Application Priority Data
Sep. 28, 2011 (JP) 2011-213298

(51) Int. Cl. G06F 17/30

(52) U.S. Cl. 707/688; 707/E17.005

(57) ABSTRACT

According to one embodiment, an information collection apparatus includes an information collector, a database, a shift width estimator, and a collection controller. The collector collects time-series data from a start time with a period of collection. The database accumulates the time-series data. The shift width estimator detects a loss of data in the time-series data and estimates a shift width corresponding to a difference between a time the loss has occurred and a collection time of data of an outlier. The collection controller obtains a correction value of the start time and a correction value of the collection period to eliminate the shift width, and controls the collection of the time-series data.

### CROSS-REFERENCE TO RELATED APPLICATIONS

This application is based upon and claims the benefit of priority from prior Japanese Patent Application No. 2011-213298, filed Sep. 28, 2011, the entire contents of which are incorporated herein by reference.

### FIELD

Embodiments described herein relate generally to a system, an apparatus, and a program for hierarchical information collection.

BACKGROUND

A conventional information collection system imparts a data acquisition time designation function and a reacquisition triggering function to the lower center (information collection system), thereby efficiently collecting information. A wide-area information collection system is assumed to be operated in a multivendor environment. Hence, in many cases, the lower center does not have the functions, and it is difficult for the upper center to efficiently collect information.

### BRIEF DESCRIPTION OF THE DRAWINGS

FIG. 1 is a block diagram showing a hierarchical information collection system according to the first embodiment;

FIG. 2 is a flowchart showing the operation of an information collection apparatus;

FIG. 3 is a graph for explaining a data loss detection method;

FIG. 4 is a flowchart showing data loss detection and shift width estimation operations;

FIG. 5 is a graph for explaining estimated loss time derivation;

FIG. 6 is a sequence chart showing an example of the sequence of start time control;

FIG. 7 is a flowchart showing an example of start time control;

FIG. 8 is a block diagram showing a hierarchical information collection system according to the second embodiment; and

FIG. 9 is a flowchart showing the operation of an information collection apparatus according to the second embodiment.

### DETAILED DESCRIPTION

In general, according to one embodiment, there is provided an information collection apparatus that includes an information collector, a database, a shift width estimator, and a collection controller. The collector collects time-series data from a start time with a period of collection. The database accumulates the time-series data. The shift width estimator detects a loss of data in the time-series data and estimates a shift width corresponding to a difference between a time the loss has occurred and a collection time of data of an outlier. The collection controller obtains a correction value of the start time and a correction value of the collection period to eliminate the shift width, and controls the collection of the time-series data.

### First Embodiment

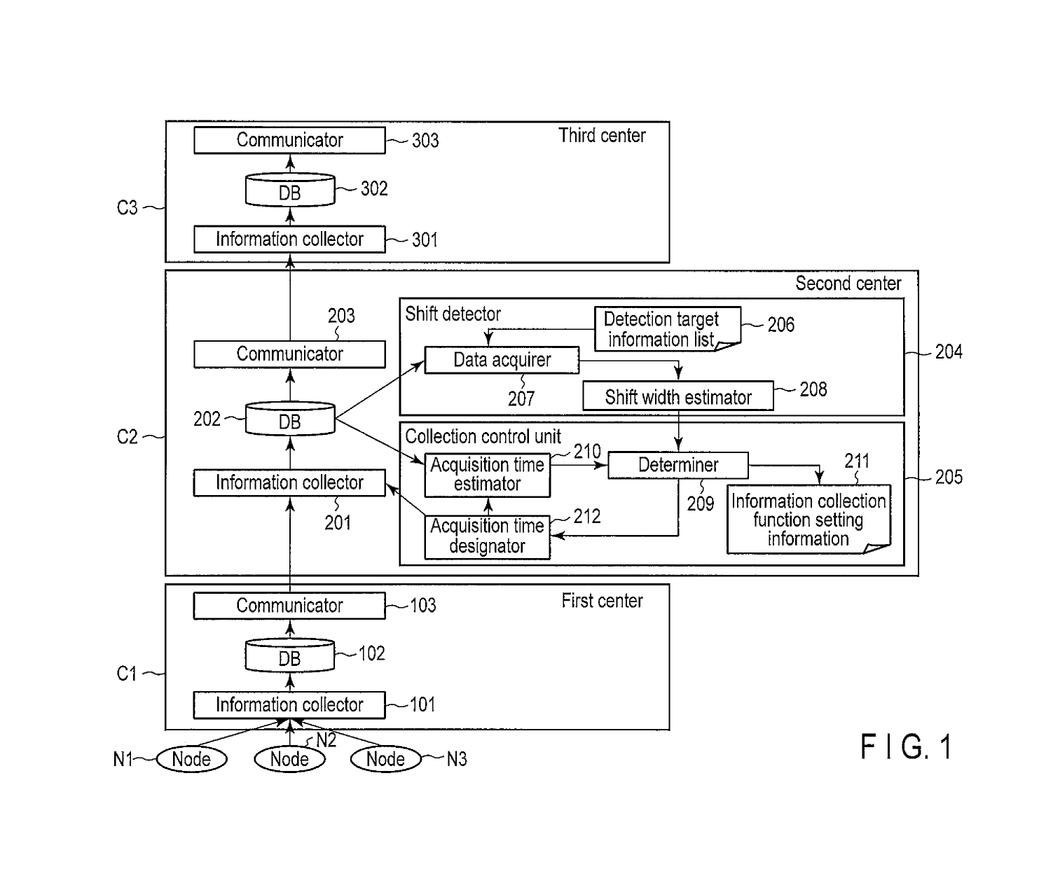

FIG. 1 is a block diagram showing a hierarchical information collection system according to the first embodiment. The hierarchical information collection system according to the first embodiment includes a plurality of centers (in this embodiment, for example, three centers including a first center C1, a second center C2, and a third center C3) that are hierarchically connected. Each center serves as an information collection apparatus for collecting and providing information. In particularly, the first center periodically collects information from building equipment of buildings of various types via a network.

### First Center C1

The first center C1 includes an information collector 101, a DB (database) 102, and a communicator 103. The information collector 101 sends a query that is an inquiry about data acquisition or a control instruction for equipment or a machine to, for example, nodes N1 to N3 of building equipment. The building equipment includes a measuring device. The information collector 101 can collect operation information of the building equipment or the like by receiving a response message to the query from each node. Operation information of, for example, air conditioning equipment includes measured values of room temperature, power consumption, and the like, integrated values of operation time, power consumption, and the like, and status values such as an on/off state and a heating/cooling mode. Accessing a point (monitor control point) via a network allows to acquire information at the time of access.

In this embodiment, the nodes N1 to N3 are assumed to be, for example, pieces of building equipment which are operating in buildings in various places. Building types include not only office buildings in various scales such as a small-scale office building having a total floor area of 3,000 m² or less, a medium-scale office building having a total floor area of several tens of thousands m², and a large-scale office building having a total floor area of 50,000 m² or more but also commercial facilities, amusement facilities, production facilities, government facilities, medical facilities, and educational facilities. In each building, air conditioning equipment, lighting equipment, power supply equipment, plumbing equipment, security equipment, anti-disaster equipment, elevator equipment, and the like, which are designed based on the scale and application purpose of the building, are maintained and operated.

The first center C1 offers the information collected from the nodes directly to the second center C2 via the communicator 103, or accumulates the information in the DB 102 in the form of a database or a file and then offers it indirectly to the second center C2. The communicator 103 may be implemented as a function of the first center C1 in the form of, for example, a download function on a web browser screen or the SQL processing function of database middleware.

### Second Center C2

The second center C2 includes an information collector 201 that collects information from at least one first center C1, a DB 202 that accumulates the information collected by the information collector 201, a communicator 203 that sends the information accumulated in the DB 202 to the upper layer for reuse, a shift detector 204 that detects the shift of the collection period start time of information collection from the information accumulated in the DB 202, and a collection controller 205 that corrects the shift of the collection period start time detected by the shift detector 204. The shift detector 204 includes a data acquirer 207 that acquires time-series data from the DB 202 based on a detection target information list 206, and a shift width estimator 208 that detects a data loss in the data acquired by the data acquirer 207 and estimates the shift width of the data collection start time. The collection controller 205 eliminates the shift width and decides an appropriate data collection start time and collection period based on the shift width of the data collection start time estimated by the shift detector 204, thereby updating information collector setting information 211. The collection controller 205 includes a determiner 209, an acquisition time estimator 210, and an acquisition time designator 212. The shift detector 204 and the collection controller 205 will be described later in detail with reference to flowcharts.

### Third and Subsequent Centers

The third center C3 (or a center (not shown) of higher level) collects information from the second center C2 or a center of higher level so as to collect information of the target area of the hierarchical information collection system. The third center C3 includes an information collector 301, a DB 302, and a communicator 303. The third center C3 preferably has the same internal arrangement as that of the second center C2 because the same problem may arise due to hierarchization.

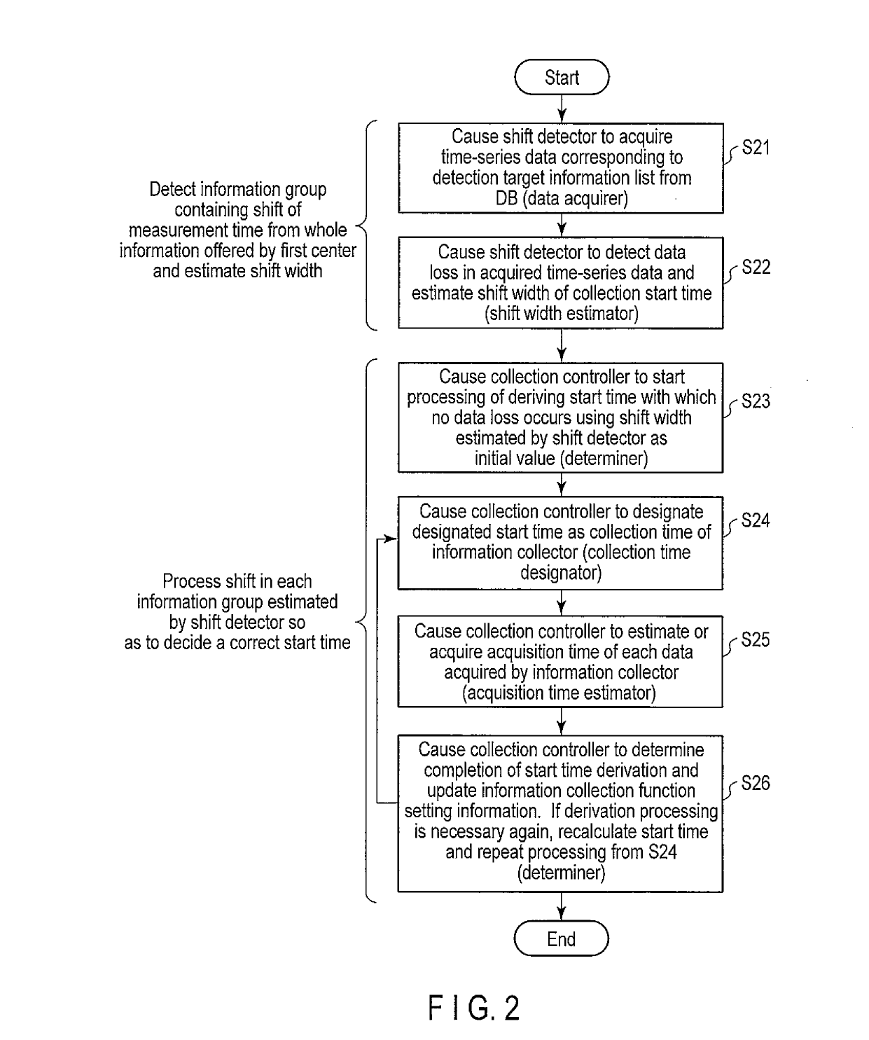

The operation of the information collection apparatus will be explained with reference to FIG. 2 while placing focus on the operation of the second center C2. The overall operation of the second center C2 is as follows. The information collector 201 collects information from the first center C1 and accumulates it in the DB 202. The shift detector 204 detects an information group containing a shift of measurement time (that is, data collection start time) from whole information offered by the first center C1, and estimates the shift width. The collection controller 205 processes the shift of the measurement time in each information group estimated by the shift detector 204 so as to decide a correct start time.

First, an example of the operation (steps S21 and S22) of the shift detector 204 will be described. The data acquirer 207 acquires time-series data described in the predetermined detection target information list 206 from the DB 202 (step S21). The detection target information list 206 is defined by an information structure such as an information group table or a point table.

The information group is, for example, information representing grouping for each building equipment, and indicates a processing unit of information collection in the first-center C1 or a unit obtained by dividing or combining the processing units. In a building, a necessary monitor control function generally changes between the subsystems of equipment, and a communication module for measurement control is provided in that unit. Needless to say, this is merely a typical example.

The point table is a table representing the points (monitor control points) of the information group table. For, for example, the information group of the power receiving/distributing subsystem, the point table stores a list of measured values of sensors for the integral power consumption, instantaneous power, instantaneous voltage, instantaneous current, and the like of the incoming point and the distribution board.

Table 1 shows an example of the information group table, and Table 2 shows an example of the point table.

TABLE 1
<<Example of Information Group Table>>

| Information group identifier | Information group type |
|---|---|
| /Center1/Building1/Power1 | Power |
| | receiving/distributing |
| | subsystem 1 |
| /Center1/Building1 | Air conditioning |
| /AirConditioner1 | subsystem 1 |
| /Center1/Building2/Power1 | Power |
| | receiving/distributing |
| | subsystem 1 |
| . . . | |

TABLE 2
<<Example of Point Table of /Center1/Building2
/Equipment 1 Information Group>>

| Point identifier | Point type | Unit |
|---|---|---|
| /SubEquipment1/Meter1 | Integral power consumption | Wh |
| /Accumlator1 | 1 of meter 1 of | |
| | distribution board 1 | |
| /SubEquipment1/Meter1 | Instantaneous power of | W |
| /Power1 | meter 1 of distribution | |
| | board 1 | |
| /SubEquipment2/Meter1 | Integral power consumption | Wh |
| /Accumlator1 | 1 of meter 1 of | |
| | distribution board 1 | |
| . . . | | |

The data acquirer 207 of the shift detector 204 acquires, from the DB 202, time-series data described in the information group specific point table as a detailed example of the detection target information list 206 for a predetermined period (for example, for one day). Next, the shift width estimator 208 of the shift detector 204 detects a data loss from the acquired time-series data and estimate the shift width of the collection start time (step S22).

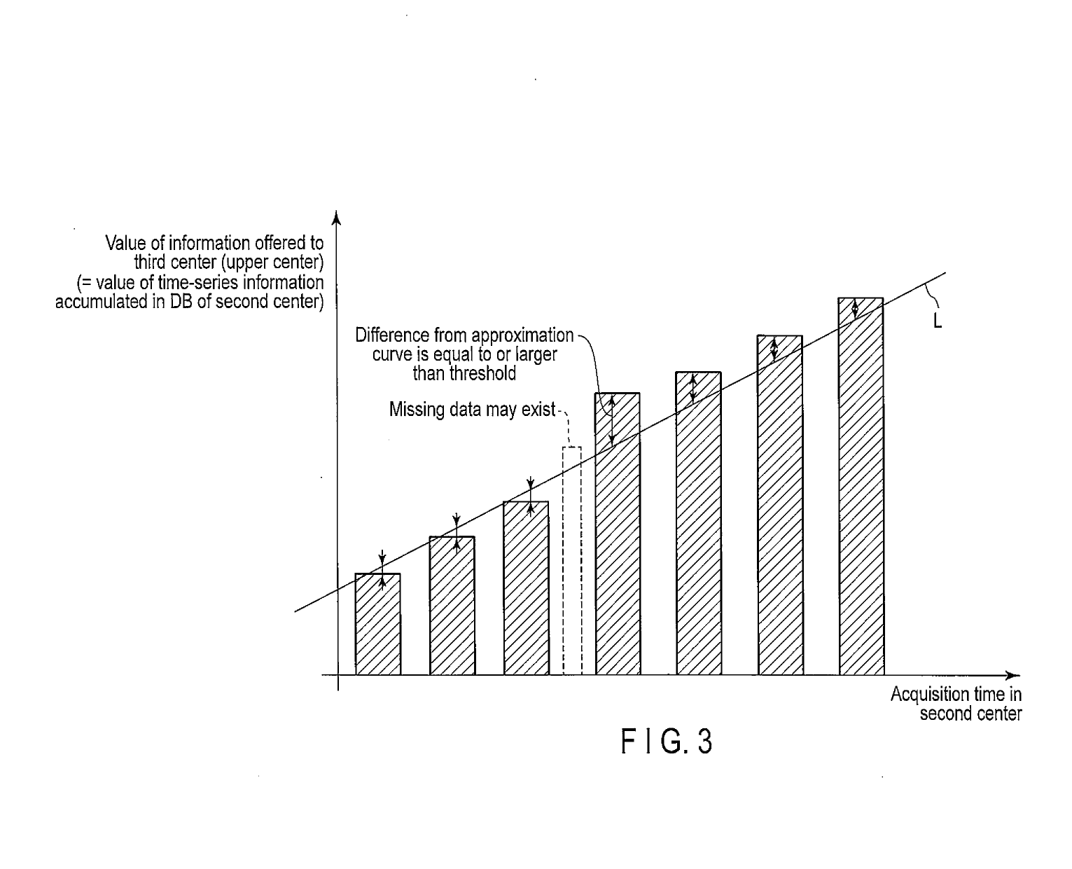

The operation of step S22 to detect a data loss and estimate the shift width of the collection start time will be described with reference to FIGS. 3, 4, and 5.

FIG. 3 is a graph for explaining a data loss detection method.

In the graph shown in FIG. 3, the abscissa represents the data acquisition time in the second center C2, and the ordinate represents the value of information offered to the third center C3 (upper center), that is, the value of time-series data accumulated in the DB 202 of the second center C2. The time-series change varies depending on the properties of detection target information. Examples of such time-series data are an incoming point integrated value, an incoming point instantaneous value, an outside air temperature/humidity value, an operation time value, and a sensor measurement time value. As is apparent from FIG. 3, if the difference between the value of time-series data and an approximation curve L based on the least squares method or the like becomes equal to or larger than a threshold, a data loss may have occurred.

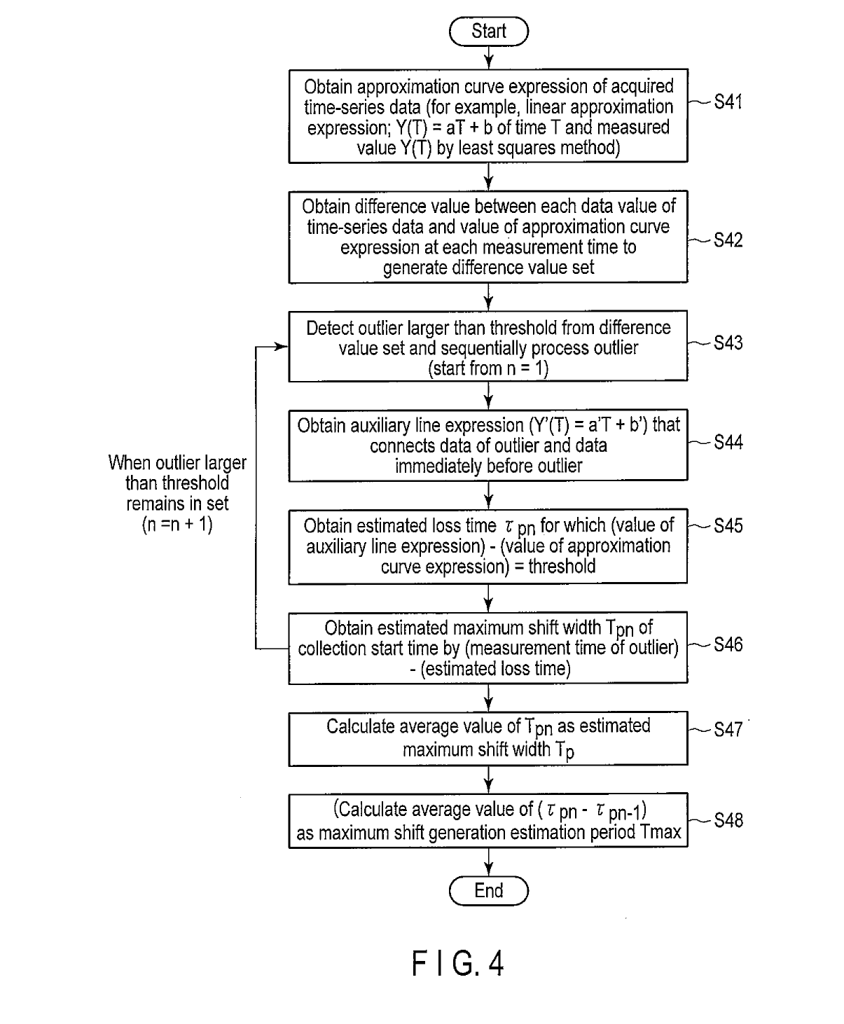

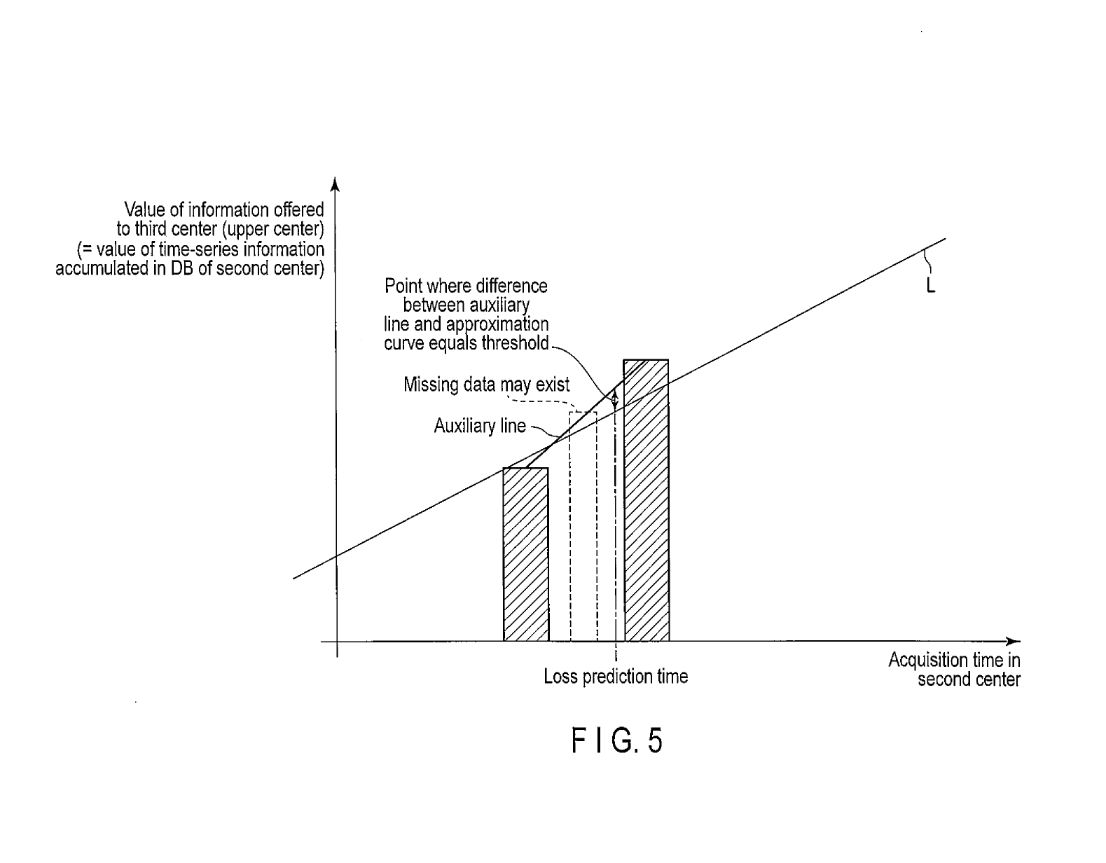

FIG. 4 is a flowchart showing data loss detection and shift width estimation operations. FIG. 5 is a graph for explaining estimated loss time derivation.

### Step S41

The approximation curve expression of the acquired time-series data is obtained. The approximation curve expression can be obtained as a linear approximation expression of a time T and a measured value Y(T) that is, Y(T)=aT+b by, for example, the least squares method.

### Step S42

The difference value between each data value of the time-series data and the value of the approximation curve expression at each measurement time is obtained to generate a difference value set.

### Step S43

An outlier larger than the threshold is detected from the difference value set and processed sequentially (processing starts from n=1).

### Step S44

As shown in FIG. 5, an auxiliary line expression (Y′(T)=a′T+b′) that connects the data of the outlier and data immediately before the outlier is obtained.

### Step S45

As shown in FIG. 5, an estimated loss time τₚₙ for which “(value of auxiliary line expression)−(value of approximation curve expression)=threshold” is obtained.

### Step S46

An estimated maximum shift width Tpn of the collection start time is obtained by (measurement time of outlier)−(estimated loss time). If an outlier larger than the threshold remains in the set, n=n+1 is set, and the process returns to step S43.

### Step S47

The average value of Tpn is calculated as an estimated maximum shift width Tp.

### Step S48

The average value of (τₚₙ−τₚₙ₋₁) is calculated as a maximum shift generation estimation period Tmax.

The shift detector 204 thus detects a loss of time-series data caused by the shift of the acquisition start time, and calculates the estimated loss time and the estimated maximum shift width of information collection by the current start time (the maximum value of the difference between the time the first center C1 starts information offer and the time the second center C2 collects information).

### Procedure of Shift Adjustment

Referring back to the flowchart of FIG. 2, an example of the operation of the collection controller 205 of the second center C2 will be described.

The determiner 209 of the collection controller 205 starts processing of deriving a start time with which no data loss occurs using the shift width estimated by the shift detector 204 as the initial value (step S23). The determiner 209 also determines completion of start time derivation and updates the information collector setting information 211. If derivation processing is necessary again, the start time is recalculated, and processing of steps S24 and S25 is repeated (step S26). In step S24, the acquisition time designator 212 of the collection controller 205 designates the designated start time as the collection time of the information collector 201. In step S25, the acquisition time estimator 210 of the collection controller 205 estimates or acquires the acquisition time of each data acquired by the information collector.

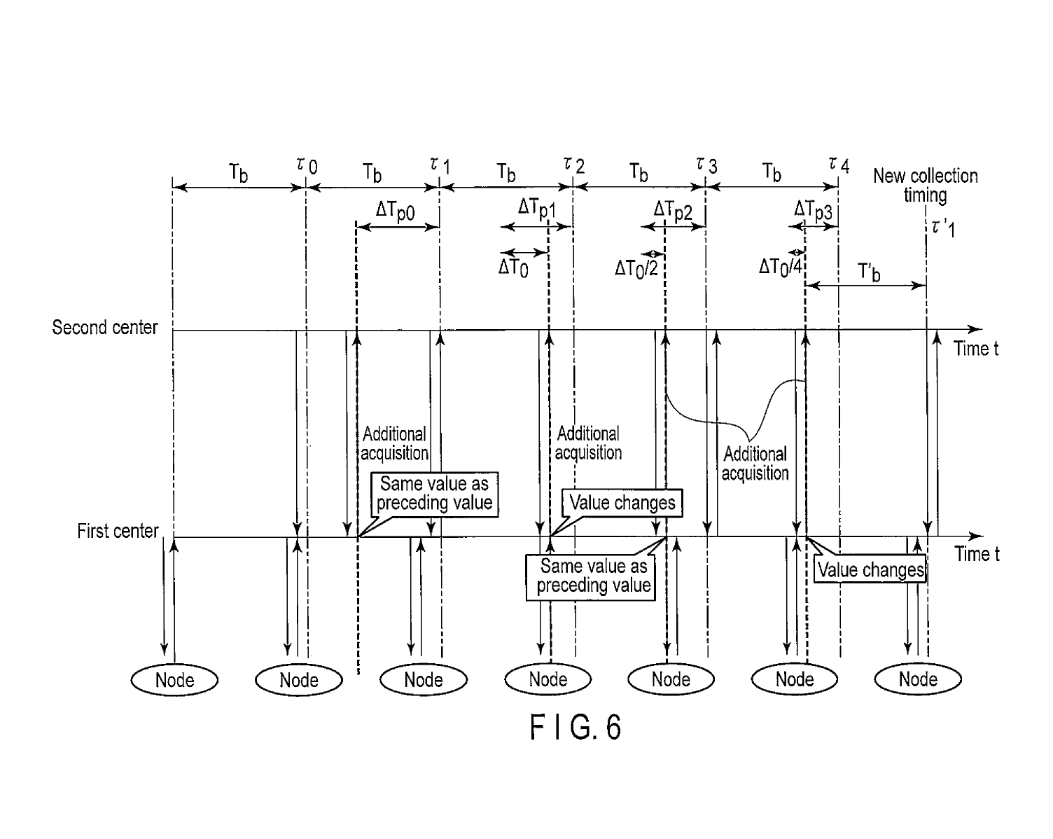

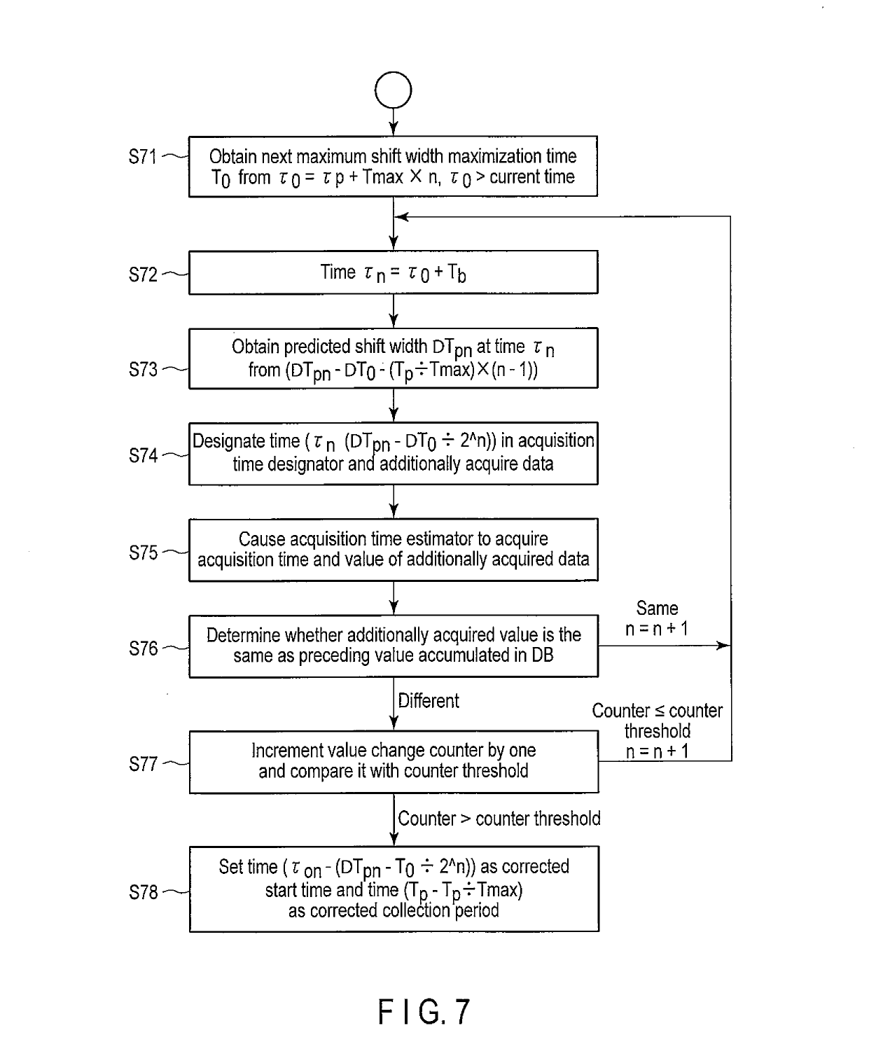

FIG. 6 is a sequence chart showing an example of the sequence of start time control. FIG. 7 is a flowchart showing an example of start time control by the collection controller 205. Referring to FIG. 6, τₙ is the nth collection time, T_{b} is a predetermined collection period, ΔTₚₙ is the nth predicted shift width, ΔT₀ is the start time correction reference value. Additional data acquisition is performed while reducing the start time correction reference value. The presence/absence of a value change is determined. A corrected collection period T′_{b} and an nth corrected collection time τ′ₙ are thus obtained.

More specifically, the corrected collection period T′_{b} and the nth corrected collection time τ′ₙ can be obtained in accordance with the flowchart of FIG. 7. Note that τₚ is the estimated loss time, Tp is the estimated maximum shift width, and Tmax is the maximum shift generation estimation period.

### Step S71

A next maximum shift width maximization time τ₀ is obtained from “τ₀=τₚ+Tmax×n, τ₀>current time”.

### Step S72

Time τₙ=τ₀+T _{b} is set.

### Step S73

The predicted shift width ΔTₚₙ at the time τₙ is obtained from “ΔTₚₙ=Tₚ−(Tₚ÷Tmax)×(n−1)”.

### Step S74

A time (τₙ−(ΔTₚₙ−ΔT₀÷2̂n)) is designated in the acquisition time designator 212, and data is additionally acquired.

### Step S75

The acquisition time estimator 210 acquires the acquisition time and value of the additionally acquired data.

### Step S76

It is determined whether the additionally acquired value is the same as the preceding value accumulated in the DB 202. If the values are different, the process advances to step S77. If the values equal, n=n+1 is set, and the process returns to step S72.

### Step S77

The value change counter is incremented by one and compared with the counter threshold. If the counter value exceeds the counter threshold, the process advances to step S78. If the counter value is equal to or smaller than the counter threshold, n=n+1 is set, and the process returns to step S72.

### Step S78

A time (τ₀ₙ−(ΔTₚₙ−ΔT₀÷2̂n)) is set as the corrected start time, and a time (Tₚ−Tₚ÷Tmax) is set as the corrected collection period.

The above-described procedure is merely a basic procedure, and more efficient processing can be executed by finer tuning.

For example, concerning the shift detector 204, the points (monitor control points) to be processed in the flowchart shown in FIG. 4 are narrowed down to points such as the operation time value and the sensor measurement time value that tend to temporarily monotonically increase or points such as the incoming point integrated value and the outside air temperature/humidity value whose change tendency is easy to estimate from similar past data (the history of the preceding day or the history of the same day of the preceding year). Shift detection and shift width estimation are performed in this state so as to regard the detected shift width as the shift width of the information group including the points. The detection processing can be expected to be more efficient.

Additionally, when the shift detector 204 uses, as the approximation curve expression, a curve of an expression/sequence easy to do curve fitting, such as a polynomial curve (for example, Y(T)=aT²+bT+c or Y(T)=aT³+bT²+cT+d), an expression of a conic section or a trigonometric curve, or an empirical rule curve (for example, the electric energy change curve of the same day of the preceding year) obtained from the past data of a point of interest, thereby reducing errors between the estimated loss time τₚₙ and the actual loss time.

Furthermore, instead of regarding the maximum shift generation estimation period Tmax as time-series data including one variable component, the shift detector 204 obtains long-term time-series data of one week or several months as a population, performs frequency analysis such as Fourier transformation to obtain the composition ratio of a plurality of variable components, and sets a period with the maximum ratio as the maximum shift generation estimation period Tmax, thereby increasing the estimation accuracy.

Also, instead of only calling the shift detector 204 as batch processing, shift detection is concentrated to timings where the start time shift may occur in many points, such as the timing the system of the second center C2 is operated again at the time of maintenance and the timing of starting connection to the first center C1. The data collection start time and the collection period are thus corrected by start time control, thereby efficiently collecting time-series data with a small worst value of information freshness.

For the start time correction reference value ΔT₀ to be used to correct the nth predicted shift width ΔTₚₙ, the collection start controller can use not only a method of decreasing the value by ½ like binary search but also an algorithm for more quickly deriving the corrected collection time by, for example, decreasing the width by an equal value ΔT₀₀ of the start time correction reference value ΔT₀ or speculatively estimating the value based on a difference value sequence obtained by the past empirical rule for the predicted shift width ΔTₚₙ.

In addition, the collection start controller can designate the information collection start time by designating the information notification time using an interface or a setting means independently prepared by the system of the first center C1 even when the first center C1 offers information by push distribution.

As described above, according to the first embodiment, the information collection side (in this example, second center C2) has the function of detecting the shift of the collection period start time and the function of controlling the collection period start time. Additionally, using data such as the electric energy of the incoming point whose value is expected to change in each measurement, the shift is detected from time-rate change of the data, and the base point time is derived from the data update timing. This allows to collect information of high freshness without adding a function to the information offer side (the system of the first center C1).

### Second Embodiment

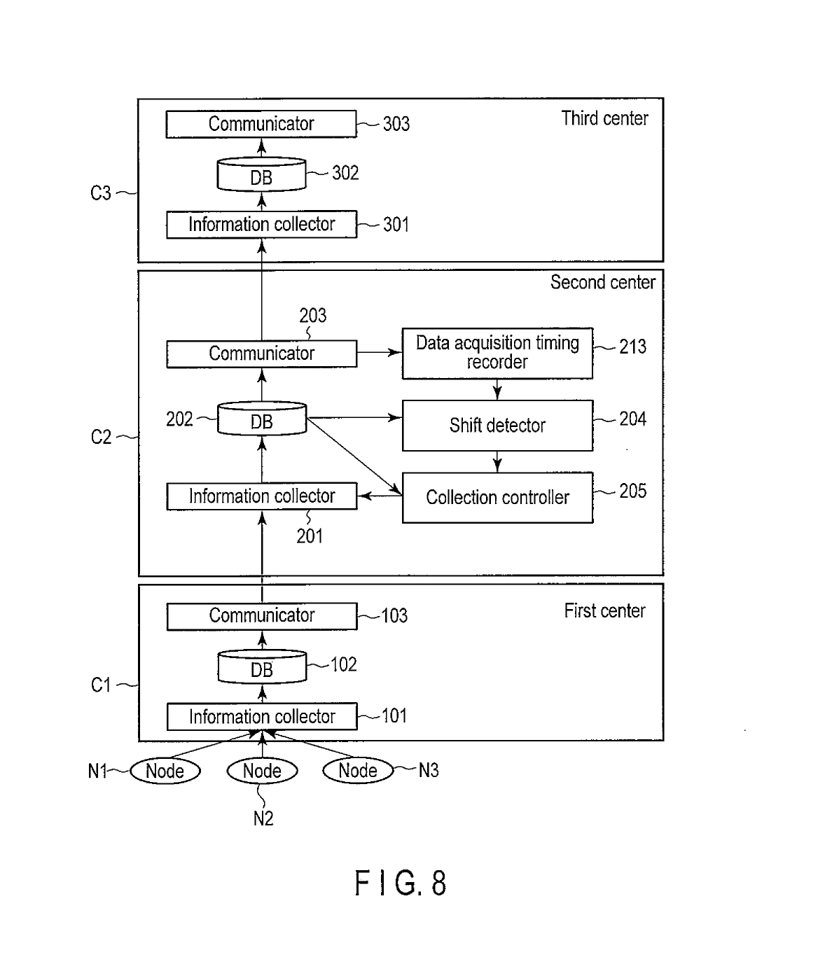

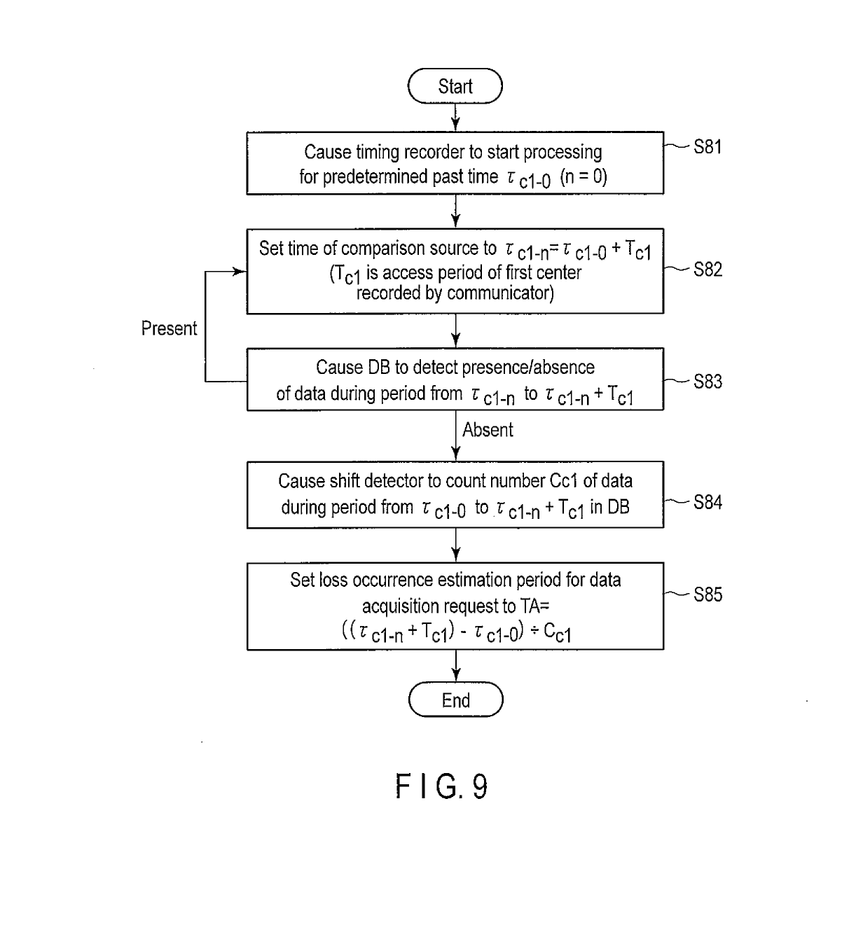

FIG. 8 is a block diagram showing a hierarchical information collection system according to the second embodiment. FIG. 9 is a flowchart showing the operation of an information collection apparatus according to the second embodiment. The arrangement of the second embodiment is different from that of the first embodiment in that a second center C2 includes a data acquisition timing recorder 213 that time-serially records the arrival time of a data acquisition request (query) from a third center C3 corresponding to a system or application for reusing information of the second center C2 and an acquisition target list (an information group table and a point table). The remaining constituent elements are the same as in the first embodiment.

FIG. 9 shows an example of the operation of detecting a section where information acquisition from a first center C1 (the lowermost center connected to a device such as building equipment or an electrical appliance) is not performed in each time-series section of the arrival time. Note that if the data acquisition period of the first center C1 changes between the items of the acquisition target list, the list is divided for each data acquisition period, and the processing of FIG. 9 is applied to each list.

### Step S81

The data acquisition timing recorder 213 starts processing for a predetermined past time τ_{c1-0} (n=0).

### Step 882

The time of the comparison source is set to τ_{c1-n}=τ_{c1-0}+T_{c1}. T_{c1} is the access period of the first center C1 recorded by a communicator 203.

### Step S83

A DB 202 detects the presence/absence of data during the period from τ_{c1-n} to τ_{c1-n}+T_{c1}. If data is present, the process returns to step S82. If data is absent, the process advances to step S84.

### Step S84

A shift detector 204 counts the number Cc1 of data during the period from τ_{c1-0} to τ_{c1-n}+T_{c1} in the DB 202.

### Step S85

A loss occurrence estimation period for the data acquisition request is set to “TA=((τ_{c1-n}+T_{c1})−τ_{c1-0})÷C_{c1}”.

In addition, the shift detector 204 that cooperates with the data acquisition timing recorder 213 calculates a next loss occurrence estimation time τ_{c1} by τ_{c1}=(preceding loss occurrence time)+TA×n. Regarding a time τA₀ as the time a data acquisition loss has occurred in the second center C2, shift detection processing of the shift detector 204 is executed. More specifically, for example, in the flowchart of FIG. 9, let τ_{c1} be the next maximum shift width maximization time. The difference value for the approximation curve expression at τ_{c1} is defined as a predicted shift width ΔT, and processing described in the first embodiment is performed.

The shift detector 204 transfers the calculated estimated maximum shift width Tp and the maximum shift generation estimation period Tmax to a collection controller 205. The collection controller 205 derives a corrected start time and a corrected collection period.

The data acquisition timing recorder 213 detects a section A′n where information acquisition from the first center C1 is not performed in each time-series section of the arrival time based on the presence/absence of the section by referring to the record of the operation time of the information acquirer, and confirms that the value is smaller than the number before correction of the collection controller 205.

Note that the above-described hierarchical information collection system or apparatus can also be implemented using, for example, a general-purpose computer apparatus as basic hardware. That is, the constituent elements of the hierarchical information collection system or apparatus can be implemented by causing a processor included in the above-described computer apparatus to execute a program. At this time, the hierarchical information collection system or apparatus can be implemented either by installing the program in the computer apparatus in advance or by storing the program in a storage medium such as a CD-ROM or distributing the program via a network and installing the program in the computer apparatus as needed. The hierarchical information collection system or apparatus can also be implemented using a memory or hard disk incorporated or externally attached to the computer apparatus or a storage medium such as a CD-R, CD-RW, DVD-RAM, or DVD-R as needed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information collection apparatus comprising:
an information collector configured to collect time-series data from a start time with a period of collection;
a database configured to accumulate the time-series data;
a shift width estimator configured to detect a loss of data in the time-series data accumulated in the database and estimate a shift width corresponding to a difference between a time the loss has occurred and a collection time of data of an outlier; and
a collection controller configured to obtain a correction value of the start time and a correction value of the collection period to eliminate the shift width, and control the collection of the time-series data in accordance with the correction values.

2. The apparatus according to claim 1, wherein
the shift width estimator determines that a shift is generated when a deviation between the outlier and an approximation curve based on the time-series data is not less than a threshold, and
the collection controller causes the information collector to move up a start of time-series data collection by a variable move-up time so as to obtain a timing at which a latest value of the collected time-series data stops changing, and obtains the correction value of the start time and the correction value of the collection period based on the timing.

3. The apparatus according to claim 1, wherein time-series data includes an incoming point integrated value, an incoming point instantaneous value, an outside air temperature/humidity value, an operation time value, and a sensor measurement time value.

4. A computer-readable medium storing a program, the program comprising:
collecting time-series data from a start time with a period of collection;
accumulating the time-series data in a database;
detecting a loss of data in the time-series data accumulated in the database and estimating a shift width corresponding to a difference between a time the loss has occurred and a collection time of data of an outlier; and
obtaining a correction value of the start time and a correction value of the collection period to eliminate the shift width, and controlling collection of the time-series data in the collecting the time-series data in accordance with the correction values.

5. The medium according to claim 4, wherein the program further comprises:
determining that a shift is generated when a deviation between the outlier and an approximation curve based on the time-series data is not less than a threshold;
moving up a start of time-series data collection by a variable move-up time;
obtaining a timing at which a latest value of the time-series data stops changing; and
obtaining the correction value of the start time and the correction value of the collection period based on the timing.

6. The medium according to claim 4, wherein time-series data includes an incoming point integrated value, an incoming point instantaneous value, an outside air temperature/humidity value, an operation time value, and a sensor measurement time value.

7. A hierarchical information collection system in which a first information collection apparatus and a second information collection apparatus are hierarchically connected,
wherein the first information collection apparatus comprises:
a first information collector configured to collect time-series data from a measurement device;
a first database configured to accumulate the time-series data collected by the first information collector; and
a first communicator configured to send the time-series data accumulated in the first database to the second information collection apparatus;
the second information collection apparatus comprises:
a second information collector configured to collect the time-series via the first communicator from a start time with a period of collection;
a second database configured to accumulate the time-series data collected by the second information collector;
a shift width estimator configured to detect a loss of data in the time-series data accumulated in the second database and estimate a shift width corresponding to a difference between a time the loss has occurred and a collection time of data of an outlier; and
a collection controller configured to obtain a correction value of the start time and a correction value of the collection period to eliminate the shift width, and control the collection of the time-series data in accordance with the correction values.
